(19) United States
(12) Patent Application Publication
(10) Pub. No.: US 2023/0338784 A1
(43) Pub. Date: Oct. 26, 2023

(54) BASKETBALL TRAINING SYSTEM

(71) Applicant: Jenna GIACONE, Delmar, NY (US)

(72) Inventor: Jenna GIACONE, Delmar, NY (US)

(21) Appl. No.: 18/297,336

(22) Filed: Apr. 7, 2023

Related U.S. Application Data
(60) Provisional application No. 63/363,419, filed on Apr. 22, 2022.

(51) Int. Cl. A63B 47/02; A63B 69/00; B25J 1/04

(52) U.S. Cl. CPC A63B 47/02; A63B 69/0071; B25J 1/04; A63B 2225/687

(57) ABSTRACT

An apparatus for securing a basketball includes a pole section; a claw assembly located at a first end of the pole section. The claw assembly includes a plurality of fingers extending axially and radially away from the first end of the pole section, wherein the fingers are sized and configured to extend over the outer surface of a basketball to secure the basketball within the fingers. A method of handling a basketball using the apparatus includes providing a basketball; and securing a basketball between the plurality of fingers. The method further includes wedging the basketball between a basketball rim and backboard while the basketball is secured between the plurality of fingers to maintain the basketball in a wedged position between the rim and backboard. A player may train and improve their basketball shooting ability by shooting the ball at the basket via the backboard to avoid the wedged ball.

### BACKGROUND

The present invention relates to the field of athletic training aids/devices/methods, and more particularly to an aid for greatly increasing the shooting percentage in the sport of basketball. In the prior art, basketball training aids try to simulate shooting distractions and facilitate layup improvement, but such may not force the offensive player to adjust their shot each time, may not simulate game like situations, and are challenging to use and setup.

Despite advancements in basketball training devices, current techniques for altering a players shot to increase accuracy have proven not efficient, and/or ineffective. The prior art does not include systems which are sufficient to grasp a basketball or basketball like size objects.

In addition to the aforementioned problem, prior methods or devices can be difficult and/or inconvenient to use and/or time consuming to setup. The present invention eliminates such difficulties and provides an easy and convenient way to wedge an object between the basketball hoop backboard and the basketball hoop rim. Furthermore, the present invention eliminates the time spent setting up a shot altering device.

In view of the current techniques/devices/methods, there remains a need for a device that can provide an easy and convenient means of wedging a basketball or basketball like size object between the basketball hoop backboard and basketball hoop rim.

### SUMMARY OF THE INVENTION

The present invention is directed to a device having a grasping feature or grip handle, and more particularly to a handheld large claw type device having a grasping feature or grip handle which can be used to hold and wedge a basketball or basketball like size object and will be described with particular reference thereto. However, it is to be appreciated that the present invention can have other or additional applications. The device of the present invention is useful for the placement/wedging of a basketball or basketball like size object between the basketball hoop backboard and the basketball hoop rim. However, it is to be appreciated that the present invention can have other additional uses and be used to place objects in other hard to reach areas. The device of the present invention can be configured to be used while the user remains in a standing position and allows for easy placement and removal of a basketball or basketball like size object within the basketball hoop backboard and basketball hoop rim.

In accordance with one aspect, an apparatus for securing a basketball includes a pole section; a claw assembly located at a first end of the pole section. The claw assembly includes a plurality of fingers extending axially and radially away from the first end of the pole section. The fingers are sized and configured to extend over the outer surface of a basketball to secure the basketball within the fingers.

The fingers are configured to form a partial cavity to receive the basketball securely therein. The fingers are formed of a resilient material which is capable of flexing radially relative to a central axis of the pole. The fingers maintain a force radially inward relative to a central axis of the pole towards a center of the basketball. The fingers are connected to a mechanism to move the fingers radially inward and outward relative to the central axis of the basketball to adjust the size of the partial cavity. A handle may be located towards a second end of the pole. The mechanism may include one or more linkages connected between the handle and the fingers.

The one or more linkages include a collar slidable axially relative to the pole, a plurality of arms connected between the collar and plurality of fingers, and a linkage between the handle and the collar. The plurality of arms are pivotably connected to the collar and plurality of fingers.

In another aspect, a method of handling a basketball using the aforementioned apparatus includes providing a basketball and securing a basketball between the plurality of fingers.

The fingers are configured to form a partial cavity to receive the basketball securely therein. The basketball may be wedged or placed between a basketball rim and backboard while the basketball is secured between the plurality of fingers to maintain the basketball in a wedged position between the rim and backboard. The apparatus may be pulled axially away from the wedged basketball to release the basketball from the apparatus to maintain the ball wedged between the rim and backboard.

The fingers are formed of a resilient material which is capable of flexing radially relative to a central axis of the pole. The fingers maintain a force radially inward relative to a central axis of the pole towards a center of the basketball. The fingers may be connected to a mechanism to move the fingers radially inward and outward relative to the central axis of the basketball to adjust the size of the partial cavity. A handle located towards a second end of the pole. The mechanism may include one or more linkages connected between the handle and the fingers. The one or more linkages may include a collar slidable axially relative to the pole, plurality of arms connected between the collar and plurality of fingers, and a linkage between the handle and the collar. The plurality of arms are pivotably connected to the collar and plurality of fingers.

Several objectives and advantages of the present invention are:
(a) to provide a basketball training aid that provides a shooting distraction and forces the offensive player to get their shot attempt higher and wider on the backboard, ultimately increasing the offensive players shooting percentage.
(b) to provide a basketball training aid that eliminates the need to use a ladder or have the access to a capable human being to elevate themselves to the 10 foot height of a basketball rim.
(c) to provide a basketball training device that does not allow an offensive player to shoot at the bottom of the rim, being easily deflected.
(d) to provide a basketball training aid that will challenge an inside post player or an attacker to get their shot attempt high and wide enough, giving it a change to go in.
(e) to provide a basketball training aid that is light weight, durable, and easily transported from one facility to another.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a conceptual view showing use of the apparatus of the present invention;

FIG. 2 is a front perspective illustration of the large claw device in an open position according to one non-limiting aspect of the present invention;

FIG. 3 is a front perspective illustration of the large claw device in a closed position according to one non-limiting aspect of the present invention;

FIG. 4 is an enlarged front perspective illustration of the claw portion of the large claw device in an open position of the present invention;

FIG. 5 depicts an isometric view of another embodiment of the present invention and showing use of the present invention; and

FIG. 6 is a more close up view of the embodiment of FIG. 5 of the present invention.

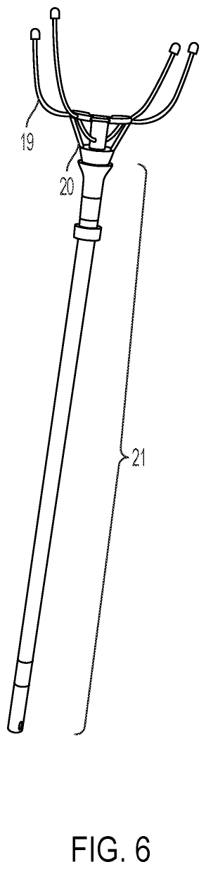

### DETAILED DESCRIPTION

In accordance with one non-limiting embodiment of the present invention there is provided a large claw device suitable for the use of placing or wedging a basketball or basketball like size object in a hard to reach area. The claw portion of the large claw device can be designed to operably move between an open and closed position; however, mechanical movement by, for example, linkages may not be required. The large claw device is configured to provide a means of placing or wedging a basketball or basketball like size object in a hard to reach area, such as between the basketball hoop backboard and basketball hoop rim.

In accordance with another and/or alternative non-limiting embodiment of the present invention, there is provided a large claw device which can include a claw portion and a handle portion separated by a pole portion and an optional actuator mechanism operably connected to the claw mechanism. The material of the claw portion, handle portion and pole portion can be the same; however, this is not required. As can be appreciated, the material of at least one of the claw portion, handle portion, and the pole portion can be different from one or more of the other components of the large claw device. In one non-limiting embodiment, the material of the one or more components of the large claw device can be a high-density polyethylene (HDPE) plastic, a low-density polyethylene (LDPE) plastic, a rubber material, polyvinyl chloride (PVC), various types of resins, various types of resin epoxides, polyester, polypropylene, polyurethane, polyacrylate, and copolymers thereof, etc. As can be appreciated, one or more components of the large claw device of the present invention can be formed from other or additional materials (e.g., metal, wood, composite materials, ceramic, etc.).

In accordance with another and/or alternative non-limiting embodiment of the present invention, the claw portion of the large claw device operates with expandable ribs, or fingers, to allow adjustment of the claw size and tension onto the object within the claw, as well as provide ease for storage, allowing the claw to collapse into a closed position; however, this is not required. The claw portion when in the opened position, expands to a diameter of 10-12 in. and, when empty and in the closed position, has a diameter of 2-5 in. The ribs or fingers of the claw portion are 4-7 in. in length. The claw portion is therefore of a sufficient size to grasp a basketball of any standard size and all sizes therebetween, including a size seven basketball (30.3-29.5 in. circumference, also commonly referred to as a “men's” basketball), a size six basketball (28.5 in. circumference, also commonly referred to as a “women's” basketball), a size five basketball (27.5 in. circumference), a size four basketball (25.5 in. circumference), a size three basketball (22-22.5 in. circumference), and a size one basketball (16 in. circumference).

In accordance with another and/or alternative non-limiting embodiment of the present invention, the pole portion of the large claw device operates with telescoping poles which are interconnected to allow for an extendable and retractable feature to the present invention, allowing for change in reach length of the large claw device; however, this is not required. The telescoping pole would extend to 4-7 ft. in length, and when in retracted position it would be 1-2 ft. in length. An alternate option would be a stick or pole, that would be 4-7 ft. in length.

In accordance with another and/or alternative non-limiting embodiment of the present invention, the handle portion of the large claw device operates with a grasping feature (if telescoping poles are used), connected through the pole portion and to the claw portion, allowing for the grasping feature of the claw portion; however, this is not required. An alternate option would be a grip handle on the handle portion of the large claw device, providing a comfortable and easy handle for the person using the device. The handle portion is 4-6 in. in length and 1-2 in. in width.

In accordance with another and/or alternative non-limiting embodiment of the present invention, the pole portion can house an actuator mechanism provided therein which is designed to cause the opening and closing feature of the large claw portion. The actuator mechanism can include a cable or rod pull system; however, this is not required. The main body of the cable or rod can traverse the interior of the pole portion and connect at its proximal end to a handle portion where the cable or rod connects to a pivot point in the handle portion; however, this is not required. The type of pivot point is non-limiting. One such pivot point is a roller pivot point with a track for guiding the cable. The distal end of the cable or rod can be connected to a flange, thereby, attached to the moveable arm; however, this is not required. As such, when the handle is moved to cause the claws to move to the closed position (e.g., the handle is compressed (i.e., squeezed), etc.) the cable or rod is caused to move toward to the top of the pole (e.g., cable is stretched and pulled around the handle pivot point, etc.) thereby causing the moveable fingers to move and cause the claw to tighten inward (i.e., close position).

In accordance with another and/or alternative non-limiting embodiment of the present invention, the handle portion can include a ridge for the purpose of improving grip to the handle and preventing the user's hand from sliding off the handle; however, this is not required.

A method of using the large claw device can comprise the following steps: situating the open-biased claw around the basketball or basketball like sized object, squeezing the handle causing the claw to approach the object and tighten around the object, thereby securing the object inside the large claw portion; moving the tightened large claw device to the desired placement/wedging area; applying light force, if necessary; and, releasing the handle so as to cause the claw portion to loosen and move to outward position and allowing the grasped object to be released. However, as can be appreciated, other or additional steps can be used.

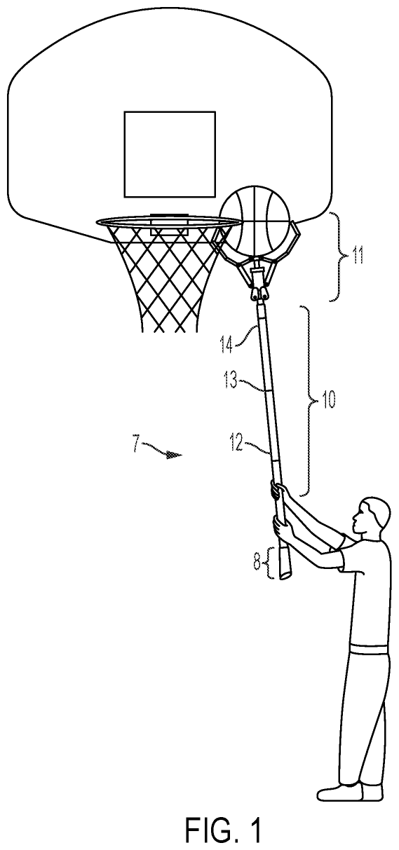

Referring to FIG. 1, the person using the present invention is able to use the large claw device 7 in order to place and/or wedge a basketball between the basketball hoop backboard and the basketball hoop rim. The large claw device 7, can be used to place other objects in hard to reach areas.

Referring now to the drawings which illustrate one non-limiting embodiment of a large claw device 7 in accordance with the present invention that is suitable for use in the placement and/or wedging of a basketball or basketball like size object within a basketball hoop backboard and a basketball hoop rim or within a hard to reach area. Although the large claw device of the present invention described herein is illustrated in an exemplary embodiment as being associated with the wedging of a basketball, the large claw device can also be used for the grasping, collection, placement etc. of many additional or other objects (e.g., other balls, balloons etc.).

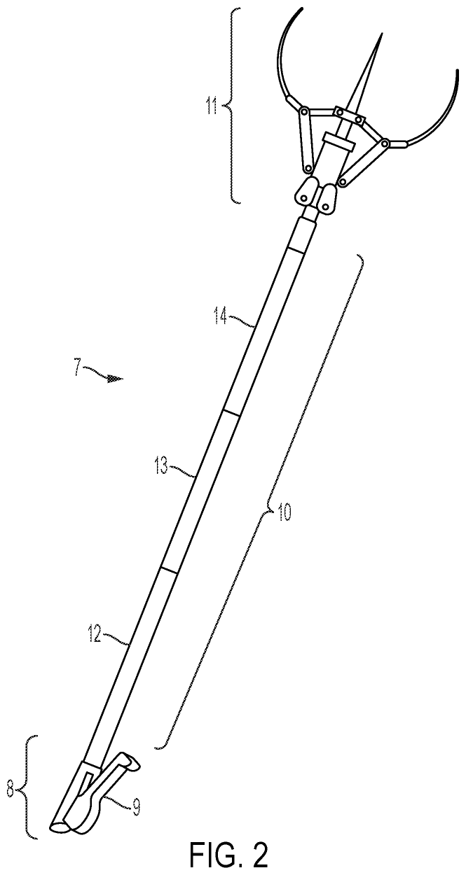

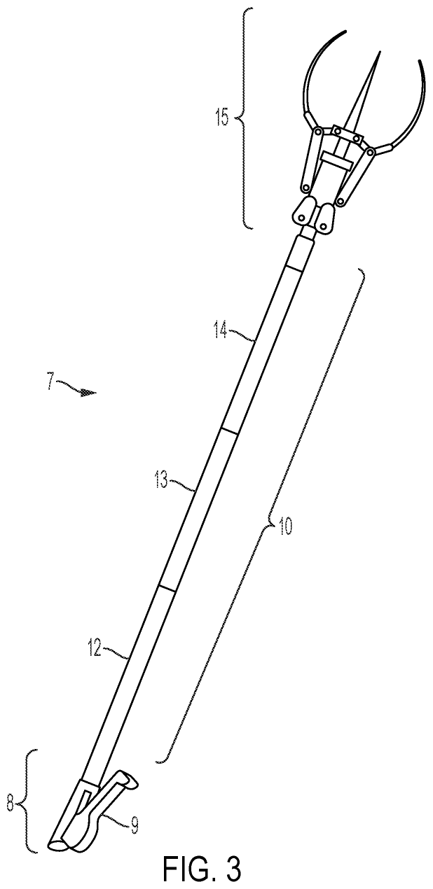

Referring now to FIGS. 2, 3 the large claw device 7 optionally comprises a handle portion 8 and a claw portion 11 separated by a pole portion 10. Claw portion 11 can be connected to pole portion 10 at one end and handle portion 8 can be connected to other end of pole portion 10. In FIG. 3 the claw portion 11 is in its closed position 15. The pole portion 10 can use telescoping tubes that are interconnected 12, 13, 14; however, this is not required. The shape, size and materials of the claw portion, the handle portion, and the pole portions are non-limiting.

Handle portion 8 can have a grasping feature 9 in order to adjust claw portion 11 from opened position and closed position 15; however, this is not required. In such an arrangement, a friction fit can be used to secure the handle portion 8 to the pole portion 10; however, other or additional arrangements can be used (e.g., adhesive, screw, rivet, threaded connection, etc.). The handle portion 8, along with the grasping arm 9, is used for the purpose of controlling the actuating mechanism of the large claw device 7; however, this is not required.

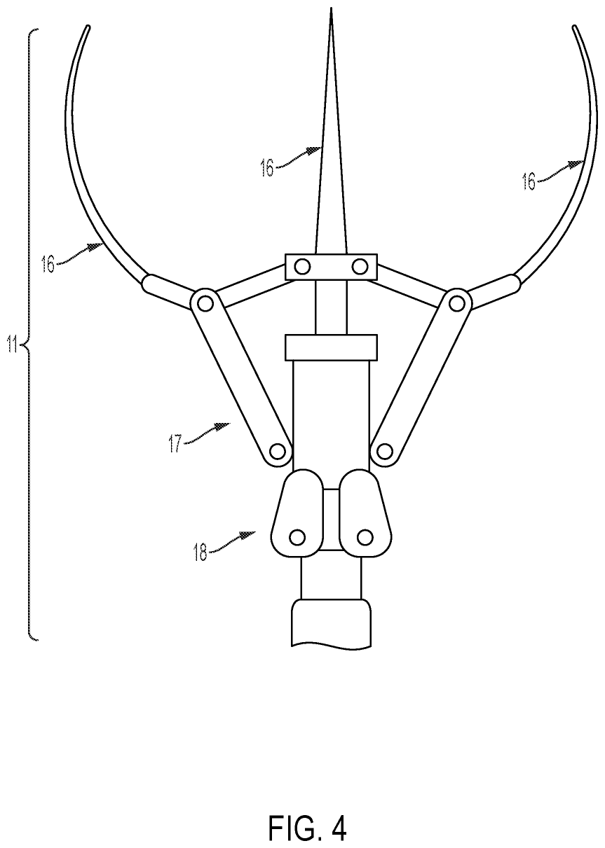

In FIG. 4 the claw portion 11 is in an enlarged front perspective. The pole portion 10 is attached to the claw portion 11 by a connection piece 18 and a base 17 of the claw portion 11. The connection 18 and the base 17 are made of the same or similar materials as the claw portions 11. The claw portion 11 has three fingers 16; however, the claw portion 11 can have 3-5 fingers or more.

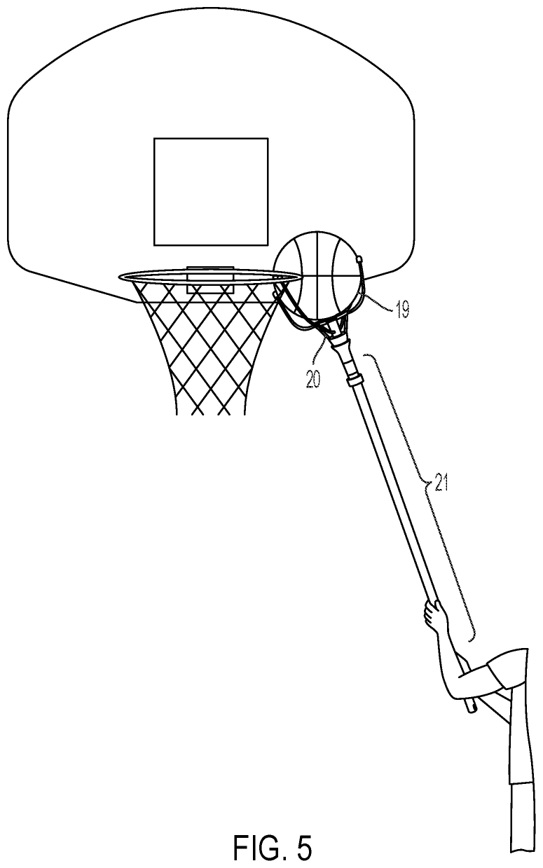

Referring to FIG. 5, 6, an example of an apparatus in accordance with the principles of the present invention is shown. Here, the fingers 19 are made with a resilient material such as rubber or plastic ties. The fingers 19 are attached to a base 20, which is sized to receive the bottom of a basketball. The example base 20 is attached to one end of the fingers 19, which as resilient, are capable of moving radially outward relative to the axis of pole 21. The base 20 is attached to the end of pole 21. The fingers move radially inward and outwardly without the use of a mechanism, but by the interference fit of a ball within the center of the cavity formed by the fingers. When the fingers are placed on the surface of the ball and the pole is moved axially towards the center of the ball, the orbital shape of the ball causes the resilient fingers to move radially outward. As the fingers slide over the surface of the ball the fingers secure the ball within the cavity formed by the fingers. Since the fingers are resilient, the fingers impart a force in the direction opposite of their radial movement. Thus, the fingers impart a force towards the center of the ball when the ball moves toward the base within the cavity formed by the fingers to secure the ball within the cavity. When the ball contacts the base 20 the ball is secured by the force imparted by fingers within the cavity formed by the fingers and base. One or more of the fingers may include a wire coaxially located along the central axis of the finger extending from on or near the base to at or near the tip of the finger. The wire may be made of a ductile material such as copper or any other soft metal, for example. The wire may be sized as 12-14 gauge; however, other sizes may also be used. The wires may allow the fingers to maintain at least in part, the shape of a curvature corresponding to the surface of the ball received on the base between the fingers, including when the ball is not received on the base.

1. An apparatus for securing a basketball comprising:
a pole section;
a claw assembly located at a first end of the pole section;
the claw assembly comprising a plurality of fingers extending axially and radially away from the first end of the pole section,
wherein the fingers are sized and configured to extend over the outer surface of a basketball to secure the basketball within the fingers.

2. The apparatus of claim 1 wherein the fingers are configured to form a partial cavity to receive the basketball securely therein.

3. The apparatus of claim 2 wherein the fingers are formed of a resilient material which is capable of flexing radially relative to a central axis of the pole.

4. The apparatus of claim 3 wherein the fingers maintain a force radially inward relative to a central axis of the pole towards a center of the basketball.

5. The apparatus of claim 1 wherein the fingers are connected to a mechanism to move the fingers radially inward and outward relative to the central axis of the basketball to adjust the size of the partial cavity.

6. The apparatus of claim 5 further comprising a handle located towards a second end of the pole.

7. The apparatus of claim 6 wherein the mechanism comprises one or more linkages connected between the handle and the fingers.

8. The apparatus of claim 7 wherein the one or more linkages comprise a collar slidable axially relative to the pole, a plurality of arms connected between the collar and plurality of fingers, and a linkage between the handle and the collar.

9. The apparatus of claim 8 wherein the plurality of arms are pivotably connected to the collar and plurality of fingers.

10. A method of handling a basketball using the apparatus of claim 1 comprising:
providing a basketball; and
securing a basketball between the plurality of fingers.

11. The method of claim 10 wherein the fingers are configured to form a partial cavity to receive the basketball securely therein.

12. The method of claim 11 further comprising wedging the basketball between a basketball rim and backboard while the basketball is secured between the plurality of fingers to maintain the basketball in a wedged position between the rim and backboard.

13. The method of claim 12 further comprising pulling the apparatus axially away from the wedged basketball to release the basketball from the apparatus.

14. The method of claim 11 wherein the fingers are formed of a resilient material which is capable of flexing radially relative to a central axis of the pole.

15. The method of claim 14 wherein the fingers maintain a force radially inward relative to a central axis of the pole towards a center of the basketball.

16. The method of claim 11 wherein the fingers are connected to a mechanism to move the fingers radially inward and outward relative to the central axis of the basketball to adjust the size of the partial cavity.

17. The method of claim 16 further comprising a handle located towards a second end of the pole.

18. The method of claim 17 wherein the mechanism comprises one or more linkages connected between the handle and the fingers.

19. The method of claim 18 wherein the one or more linkages comprise a collar slidable axially relative to the pole, plurality of arms connected between the collar and plurality of fingers, and a linkage between the handle and the collar.

20. The method of claim 19 wherein the plurality of arms are pivotably connected to the collar and plurality of fingers.
